(19) United States
(12) Patent Application Publication
(10) Pub. No.: US 2022/0399852 A1
(43) Pub. Date: Dec. 15, 2022

(54) FRAME FOR A SOLAR PANEL

(71) Applicant: Steve Leslie, Hood River, OR (US)

(72) Inventor: Steve Leslie, Hood River, OR (US)

(21) Appl. No.: 17/837,989

(22) Filed: Jun. 10, 2022

Related U.S. Application Data
(60) Provisional application No. 63/209,312, filed on Jun. 10, 2021.

(51) Int. Cl. H02S 30/10

(52) U.S. Cl. CPC H02S 30/10

(57) ABSTRACT

An improved frame for a solar panel that facilitates securing a solar panel into the frame, and facilitates connection of the frame to a mount assembly for a solar array.

### CROSS REFERENCE TO RELATED APPLICATIONS

The present application claims priority to U.S. Provisional Application No. 63/209,312 filed Jun. 10, 2021, the content of which is incorporated herein by reference in its entirety.

### BACKGROUND

The subject matter of this application relates to solar panels, and more particularly to an improved frame for housing a solar panel.

Installing a solar panel at a location typically involves constructing a mount assembly on the ground, a roof, etc, upon which an array of solar panels may be attached at a desired angle relative to the horizon. This mount assembly may typically have a plurality of rails upon which individual solar panels, each secured in a respective frame, can be sequentially mounted to assemble the array.

Assembling the frame securely around the solar panel, and subsequently mounting the framed solar panel to the rails is often a time-consuming process, however. What is desired, therefore, is an improved frame that reduces the complexity of assembling the frame around the solar panel and subsequently securing the frame to the rails of a mount assembly.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary solar panel installation where a solar panel, housed in a frame, is supported on rails of a mount assembly.

FIG. 2 shows a close-up view of the fastening mechanism for securing the frame of FIG. 1, which houses a solar panel, to the rails of the mount assembly.

FIG. 3 shows a sectional view taken along line 3-3 of FIG. 2.

FIG. 4A shows an alternate frame to that depicted in FIGS. 1-3.

FIG. 4B shows a bottom view of the frame of FIG. 4A.

FIG. 5 shows the frame of FIG. 4A, which encloses a solar panel, attached to the rail of a mount assembly.

FIG. 6 shows a sectional view taken along line 6-6 of FIG. 5.

### DETAILED DESCRIPTION

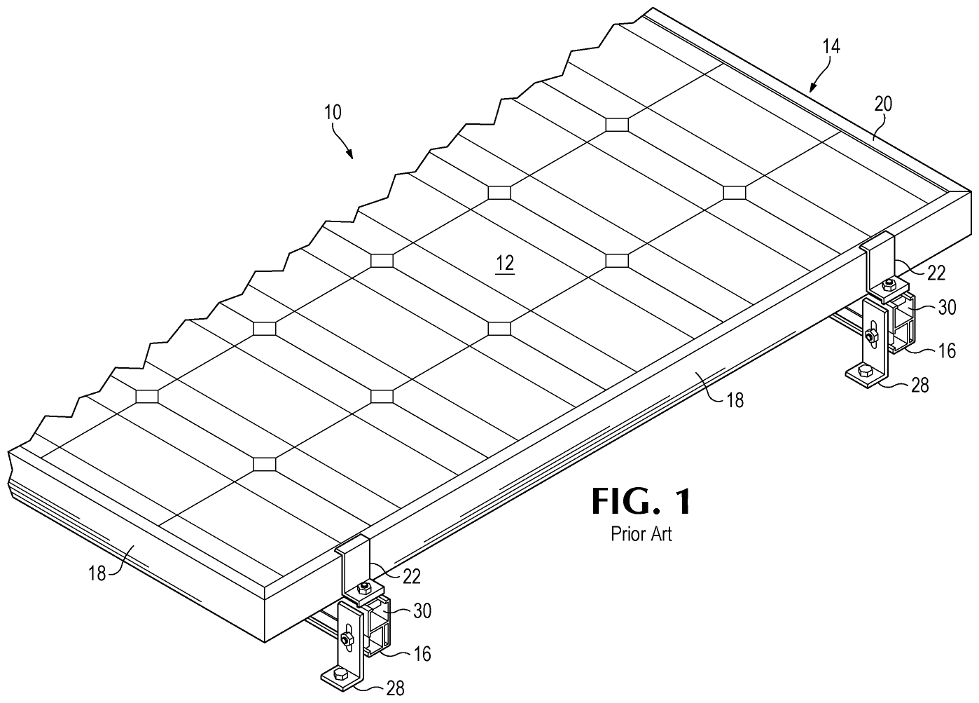

Referring to FIGS. 1-3 which show an exemplary prior art solar panel installation 10, a solar panel 12 may be rigidly secured within a frame 14 that surrounds the typically square circumference of the solar panel 12. The frame 14 may in turn be secured to rails 16 using a T-bolt assembly 16, described in more detail later in the specification. The rails 16, in turn, are secured to a mount assembly (not shown) using L-bracket fastener 28, where the mount assembly is configured to orient the solar panels at a desired angle relative to the horizon to maximize the energy flux received by the solar array over the course of a day.

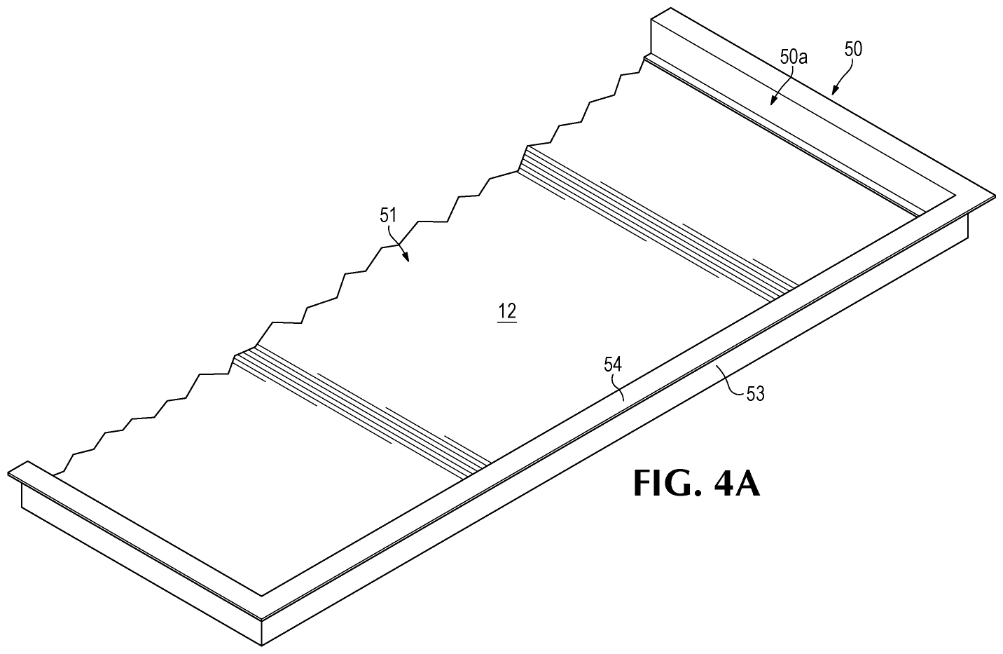

Unfortunately, assembly of the installation 10 is a time-consuming process. Initially, the frame 14 typically will be assembled around the solar panel. Referring specifically to FIG. 3, for example, the frame 14 comprises four pieces each defining a C-shaped channel 18. Each piece, for example, may be bevelled at a 45-degree angle at either end (as shown in FIG. 1) so that the pieces of the frame 14 may first be positioned around the periphery of the solar panel, then affixed to each other so as to rigidly enclose the solar panel, which overlaps a flange portion 20 of the frame 14. The solar panel 12 may also preferably be secured rigidly to the flange portion 20 so that the framed solar panel 12 is ready for mounting to the rails 16.

Mounting the frame 14 to the rails 16 is also a time-consuming procedure. Specifically, a bracket 22 is shaped to mount flush to both the top surface of flange 20 of frame 14 and an upper ledge of a channel 30 of the rail 16. Within the channel 30, a T-connector 24 having a threaded bolt 25 may be adjusted or slid to a position at which the bolt 25 protrudes through the bracket 22. A nut 26 may then be used to secure the frame in place.

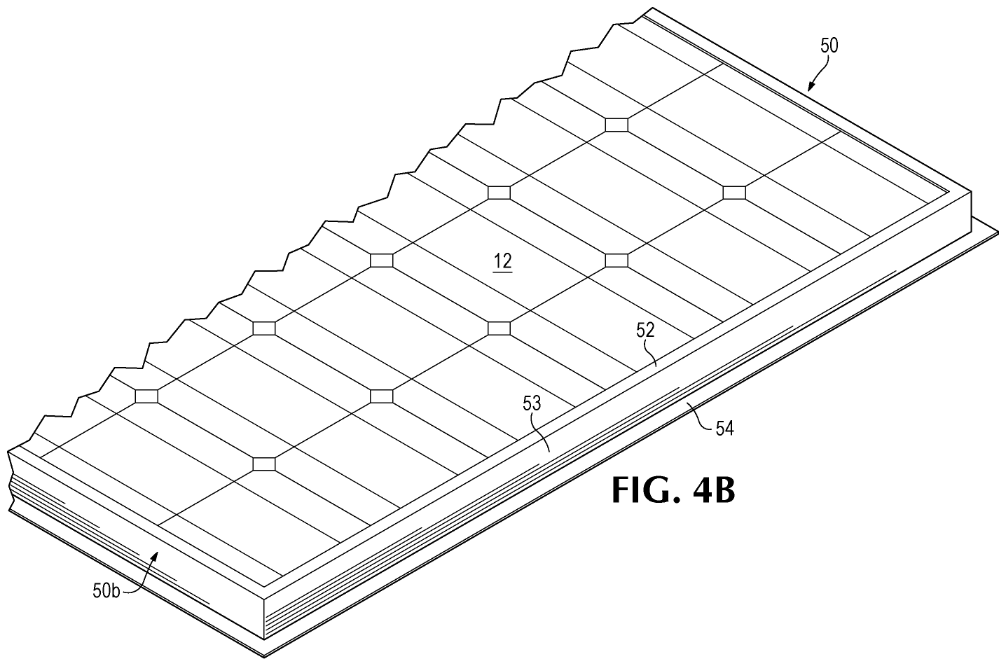

FIGS. 4A and 4B show an alternate frame 50 into which a solar panel may be much more easily secured, and which may be much more easily secured to a rail 16 of a solar mount assembly. Referring to FIG. 4A, for example, the frame 50 may include a first interior face 50a defining an interior circumferential recess 51 bounded at the bottom of the recess by an inwardly-extending horizontal flanged portion 52 of the frame 50 that supports the solar panel 12 and to which the solar panel 12 may be rigidly attached. In a preferred embodiment, the flanged portion 32 comprises two parallel flanges spaced apart by a distance roughly equal to the width of the solar panel, so that the solar panel may be supported on either side by a respective one of the flanges.

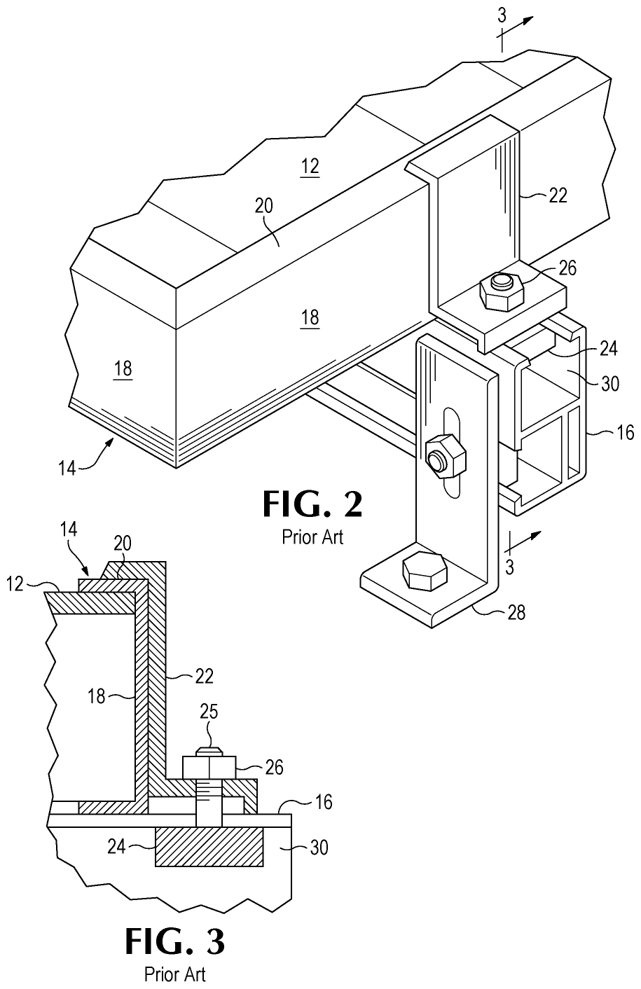

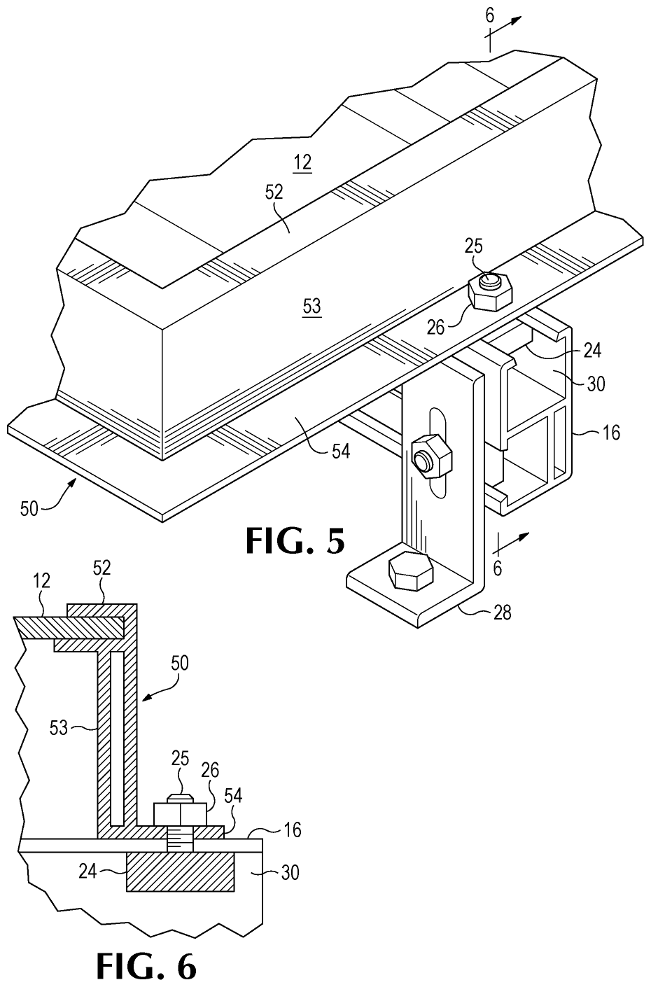

Furthermore, the frame 50 preferably has a second exterior face 50b that defines an outwardly-extending horizontal flange 54. Thus, when the frame 50 is flipped over from the orientation seen in FIG. 4A to the orientation shown in FIG. 4B, the flange 54 may be overlaid horizontally on the upper edge of the rail 16 and secured directly to the rail without the necessity of a separate bracket 22, such as that shown in FIG. 2. In some embodiments, the horizontal flange 54 may include apertures into which a threaded bolt 25 of a T-connector 26 may be inserted as seen in FIGS. 5 and 6. In other embodiments, the horizontal flange 54 may be connected to the rail 16 using any other fastener appropriate for the particular configuration of the rail 16.

In one embodiment, the recess has a first recess dimension (e.g., the length of the recess) orthogonal to a second recess dimension (e.g., the width of the recess), and the inwardly-directed flanged portion 52 bounds or forms an aperture having an first aperture dimension (e.g., the length of the aperture) orthogonal to a second aperture dimension (e.g., the width of the aperture), the first aperture dimension aligned with the first recess dimension and the second aperture dimension aligned with the second recess dimension, and at least one of the first aperture dimension and the second aperture dimension is less than that of its respectively aligned recess dimension. Preferably, both the first aperture dimension and the second aperture dimension is less than that of their respectively aligned recess dimensions.

Referring specifically to FIGS. 5 and 6, in one preferred embodiment, the frame 50 may have a cross section of a generally Z-shape. That is to say, the frame 50 may comprise a flanged portion 52 and flange 54 at opposed ends of a central vertical section 53, where the flanged portion 52 and flange 54 extend from the section 53 in opposite directions. Those of ordinary skill in the art will appreciate, however, that some embodiments may employ other cross-sectional shapes. For example, the flange 54 may also extend inwardly, as the fact that the flange 54 also extends outwardly would still prove useful since the frame 50 could still be directly attached to the rail 16.

The benefits of the frame 50 are readily apparent. First, the horizontal flange 54 eliminates the need for a separate part, such as the bracket 22 shown in FIG. 2. Instead, holes may simply be drilled in the flange 54 to attach the frame 50 to the railing 16 or any other supporting structure for solar array. In some embodiment, holes may be formed in the flange as manufactured at predetermined an uniform locations, while in other embodiments the holes may be drilled at a desired location when assembling the solar array. The cost-benefit achieved is therefore significant given that, in existing solar installations many such brackets 22 are needed for each frame/solar panel. Second, the outer flanges 54 of adjacent solar panel frames may be mounted so that they overlap, saving both space and potentially equipment costs as a single bolt may be used to secure both frames to the assembly. Third, the outer flange 54 is suitable for attachment to a wide variety of solar mount assemblies. For example, the flange 54 may be secured not only to a rail 16, but directly to a Z-purlin for example.

Those of ordinary skill in the art will understand that the frame 50 may be fabricated, constructed, or assembled in any appropriate manner. For example, the frame 50 may be fabricated as an integral piece by a stamping/rolling process. Alternatively, the frame 50 may be assembled from individual pieces as was described with respect to the frame shown in FIG. 1, where each piece has a cross-sectional shape as discussed with respect to FIGS. 4-6. In the latter circumstance, the frame 50 may preferably be part of an assembly kit including the necessary number of such frame pieces, along with any components needed to assemble the pieces together into a completed frame, secure a solar panel within the frame, and secure the frame to a rail of a mount assembly.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A frame for a solar panel comprising an interior face and an oppositely-oriented exterior face, the interior face defining a recess configured to enclose a solar panel and at least one inwardly-directed flange to support an inserted solar panel, the exterior face defining an outwardly-directed flange configured to provide a horizontal surface for being supported upon a mount assembly for solar array.

2. The frame of claim 1 where the recess has a first recess dimension orthogonal to a second recess dimension, and the inwardly-directed flange forms an aperture having an first aperture dimension orthogonal to a second aperture dimension, the first aperture dimension aligned with the first recess dimension and the second aperture dimension aligned with the second recess dimension, and at least one of the first aperture dimension and the second aperture dimension being less than that of its respectively aligned recess dimension.

3. The frame of claim 2 where both the first aperture dimension and the second aperture dimension are less than that of their respectively aligned recess dimensions.

4. The frame of claim 1 where the inwardly-directed flange and the outwardly-directed flange are each at opposed ends of a central support.

5. The frame of claim 4 where the outwardly-directed flange does not extend inwardly from the central support.

6. A frame for a solar panel comprising an outer peripheral member configured to support the solar panel within the frame, the outer peripheral member comprising an elongate central member with a first end opposed to a second end, an inwardly-directed first flange at the first end and an outwardly-directed second flange at the second end.

7. The frame of claim 1 where the inwardly-directed flange supports the solar panel and forms an aperture by which light may impinge on the solar panel.

8. The frame of claim 4 where the outwardly-directed flange does not extend inwardly from the central support.

9. An assembly comprising:
a plurality of frame members together configured for assembly into a frame shaped to support a solar panel within the frame, each frame member comprising an elongate central member with a first end opposed to a second end, a first flange extending in a first direction away from the first end and a second flange at extending in a second direction away from the second end, the second direction opposite the first direction; and
at least one connector capable of connecting the second flange to a mount assembly for a solar array.

10. The assembly of claim 9 where the frame members define a recess configured to enclose a solar panel and form at least one inwardly-directed flange to support the inserted solar panel and an outwardly-directed flange configured to provide a horizontal surface for being supported upon a rail of a mount assembly for solar array.

11. The assembly of claim 10 where the at least one inwardly-directed flange forms an aperture.

12. The frame of claim 1 where the recess has a first recess dimension orthogonal to a second recess dimension, and the aperture has a first aperture dimension orthogonal to a second aperture dimension, the first aperture dimension aligned with the first recess dimension and the second aperture dimension aligned with the second recess dimension, and at least one of the first aperture dimension and the second aperture dimension being less than that of its respectively aligned recess dimension.

13. The frame of claim 12 where both the first aperture dimension and the second aperture dimension are less than that of their respectively aligned recess dimensions.

14. The frame of claim 10 where the inwardly-directed flange and the outwardly-directed flange are each at opposed ends of a central support.

15. The frame of claim 14 where the outwardly-directed flange does not extend inwardly from the central support.
